(19) United States
(12) Patent Application Publication
(10) Pub. No.: US 2007/0122749 A1
(43) Pub. Date: May 31, 2007

(54) Method of nanopatterning, a resist film for use therein, and an article including the resist film

(76) Inventors: Peng Fei Fu, Midland, MI (US); Lingjie Jay Guo, Ann Arbor, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/290,866

(22) Filed: Nov. 30, 2005

(51) Int. Cl. G03C 5/00

(52) U.S. Cl. 430/311

(57) ABSTRACT

A method of nanopatterning includes the steps of providing a resist film (12) and forming a pattern in the resist film (12). The resist film (12) includes a copolymer consisting of an organosilicone component and an organic component. An article (10) includes a substrate (14) and the resist film (12) disposed on the substrate (14). The copolymer of the organosilicone component and the organic component is sufficiently elastic, due to the presence of the organosilicone component, to be capable of resisting fracture and delamination during mold release. Furthermore, during pattern formation, the copolymer develops relatively low surface energy at an interface with the surface of a mold, as compared to conventional polymeric materials, and preferentially adheres to the substrate (14) rather than the mold, which provides for relatively easy mold release. The presence of the organosilicone component in the copolymer also allows the resist film (12) to exhibit excellent resistance to oxygen plasma etching.

### GOVERNMENT LICENSE RIGHTS

The U.S. Government has a paid-up license in this invention and the right in limited circumstances to require the patent owner to license others on reason-able terms as provided for by the terms of grant number ECF 0424204 awarded by the National Science Foundation.

### FIELD OF THE INVENTION

The present invention generally relates to a method of nanopatterning, a resist film having a pattern formed therein, and an article including the resist film. More specifically, the resist film includes a copolymer that provides many advantages over conventional polymeric materials used in resist films for nanopatterning.

### BACKGROUND OF THE INVENTION

Nanopatterning is an essential part of nanotechnology research for fabricating nanostructures. For these nanostructures and nanopatterning techniques to have significant practical value, low cost and high throughput nanopatterning techniques are indispensable. Among many new emerging techniques that are aimed at lowering cost and increasing throughput, nanoimprint lithography (NIL) is regarded as a promising technique. NIL has the capability of patterning sub-10 nm structures, yet only entails simple equipment setup and easy processing. As such, NIL has been applied in the fabrication of numerous electric and optical devices, and also in wafer-scale processing.

One approach to NIL involves thermal embossing. For the thermal embossing, a resist film is formed on a substrate, generally through spin-coating a polymeric material onto the substrate to form the resist film. Conventional polymeric materials included in the resist film include polystyrene and poly(methyl methacrylate). A pattern is formed in the resist film with a mold under high pressures and heat.

Two critical steps during formation of the pattern are mold release and pattern transfer from a surface of the mold to the resist film. Ideal mold release results in resist shape integrity and complete mold-resist film separation, while the resist film remains attached to the substrate. When the conventional polymeric materials are used, high adhesive forces arise between a surface of the mold and the resist film due to a relatively large contact area between the surface of the mold and the resist film. The high adhesive forces often result in fracture and/or delamination of the resist film from the substrate during mold release. Furthermore, the high adhesive forces make forming large aspect-ratio structures difficult during pattern transfer, resulting in poor pattern transfer of the large aspect-ratio structures from the surface of the mold to the resist film.

One solution to the problem of poor pattern transfer is to form a planarizing film between the resist film and the substrate, then forming a short aspect-ratio structure in the resist film, thereby using the resist film as a mask to the planarizing film, and oxygen plasma etching the planarizing film through the pattern in the resist film to form the large aspect-ratio structure. For the resist film to be used as a mask, the resist film must be more resistant to oxygen plasma etching than the planarizing film. However, resist films including the conventional polymeric materials are insufficiently resistant to oxygen plasma etching, and thus do not sufficiently mask the planarizing film to enable the large aspect-ratio structures to be formed.

Thus, there remains a need for a method of nanopatterning that improves upon the deficiencies of conventional nanopatterning using the conventional polymeric materials. Namely, there remains a need for a resist film to be used in the method of nanopatterning that includes a polymeric material that is capable of resisting fracture and delamination during mold release and that exhibits excellent resistance to oxygen plasma etching.

### SUMMARY OF THE INVENTION AND ADVANTAGES

The subject invention provides a method of nanopatterning, a resist film having a pattern formed therein, and an article including the resist film. The method of nanopatterning includes the steps of providing the resist film and forming the pattern in the resist film. The resist film includes a copolymer of organosilicone component and organic component. The article includes a substrate, and the resist film is disposed on the substrate.

The organosilicone-organic copolymer provides many advantages. For example, the copolymer is sufficiently elastic, due to the presence of the organosilicone component, to be capable of resisting fracture and delamination during mold release from a surface of a mold. Furthermore, the copolymer develops relatively low surface energy at an interface with the surface of the mold during pattern transfer, as compared to conventional polymeric materials, and preferentially adheres to the substrate rather than the mold, which provides for relatively easy mold release. The presence of the organosilicone component in the copolymer also allows the resist film to exhibit excellent resistance to oxygen plasma etching.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a scanning electron microscopy (SEM) micrograph illustrating 250 nm line width patterns on a resist film of the present invention;

FIG. 2 is an SEM micrograph illustrating a metal layer, more specifically metal lines, deposited on the resist film of the present invention, the resist film having been used as a mask to etch a planarizing film beneath the resist film, and then the resist film having been partially etched to achieve liftoff of the metal lines;

FIG. 3 is an SEM micrograph illustrating a series of etched hole arrays formed using a patterned metal mask deposited on top of a resist film, with a planarizing film beneath the resist film; and

FIG. 4 is side schematic view of an article including a substrate, a planarizing layer or underlayer, and the resist film.

### DETAILED DESCRIPTION OF THE PREFERRED EMBODIMENTS

A method of nanopatterning according to the present invention is primarily used in nanotechnology research and micro- and nano-device fabrication. Known processes that may be characterized as nanopatterning include, but are not limited to, nano- and micro-lithography, such as nanoimprint lithography (NIL), thermal embossing, nanoscale contact printing, UV-assisted nanoimprint lithography, Step-and-Flash Nanoimprint Lithography (S-FIL), and combined-nanoimprint-and-photolithography. These processes have proven particularly useful in the fabrication of numerous electric and optical devices, and also in wafer-scale processing.

In nanopatterning, a resist film 12 is provided and is typically formed on a substrate 14; however, it is to be appreciated that the resist film 12 may be formed freestanding from the substrate 14. As shown in FIG. 1, a pattern is formed in the resist film 12. The pattern may be formed through various mechanisms, such as with a mold, or through masking and etching, which is described in further detail below. When the mold is used, the pattern is typically formed in the resist film 12 under high pressure and heat. More specifically, a pattern is transferred from a surface of the mold to the resist film 12. The resist film 12, in combination with the substrate 14, forms an article 10. Preferably, the substrate 14 is formed from silicon or glass, but may also be formed from metals and plastics.

The resist film 12 of the subject invention includes a copolymer consisting of an organosilicone component and an organic component. More specifically, the copolymer may be characterized as a block copolymer, which may be a multi-block copolymer such as a diblock or triblock copolymer, a graft copolymer, a random copolymer, a random graft copolymer, an alternating copolymer, etc. The copolymer is formed through copolymerization of the organosilicone component and the organic component via polymerization techniques that are known in the art, including free radical, anionic, cationic, condensation, group-transfer, or coordination polymerization process.

The organosilicone component includes a silicone group selected from the group of an (SiR₂O) group, an (SiRO_{2/3}) group, and combinations thereof, wherein R is selected from the group of an amino group, a hydroxyl group, an ether group, a carboxyl group, hydrogen, a phenyl group, a hydrocarbon group, a fluorocarbon group, and combinations thereof. For example, in one embodiment, the organosilicone component is a dialkyl silane, such as dimethoxy dimethyl silane, or a polymer of the dialkyl silane, such as poly(dimethyl siloxane). However, it is to be appreciated that R may be any functional organic group.

The use of the organosilicone component in forming the copolymer provides the copolymer with many advantageous properties. For example, the resist film 12 including the copolymer formed from the organosilicone component is capable of resisting fracture and delamination during mold release due to the presence of the silicone in the copolymer, which imparts elasticity to the resist film 12. Furthermore, during pattern transfer from the mold to the resist film 12, the copolymer provides a relatively low surface energy at an interface between the resist film 12 and the surface of the mold, as compared to conventional polymeric materials. More specifically, the copolymer undergoes microphase segregation during pattern transfer as a result of application of heat to the copolymer to form a silicone enriched surface due to its lower surface energy than a polymerization product of the organic component. The microphase segregation results in the polymerization product of the organosilicone component localizing at the interface with the surface of the mold. Conversely, the polymerization product of the organic component heavily localizes at an interface between the resist film 12 and the substrate 14. Since there is relatively low surface energy at the interface between the resist film 12 and the mold and relatively high surface energy at the interface between the resist film 12 and the substrate 14, the resist film 12 preferentially adheres to the substrate 14 rather than the mold, thereby providing for relatively easy mold release. The mold is typically treated with a fluorocarbon agent to further lower the surface energy of the mold, which also contributes to relatively easy mold release. The copolymer formed from the organosilicone component also exhibits excellent resistance to oxygen plasma etching, as described in further detail below.

Preferably, the polymerization product of the organic component has a T_{g} of no greater than 150° C., more preferably from 8 to 120° C. As a result, the copolymer preferably has a T_{g} of no greater than 150° C., more preferably from 50 to 120° C. The relative amounts of the organosilicone component and the organosilicone component may be adjusted, depending on the specific components used, to obtain the copolymer having the desired T_{g}. The copolymer having the T_{g} within the proscribed ranges has a modulus of elasticity that is sufficient to ensure excellent mechanical integrity of the resist film 12 without being too brittle. More specifically, resist films 12 formed from copolymers having a modulus of elasticity that is too high are often brittle and tend to break easily during mold separation, and resist films 12 formed from copolymers having a modulus of elasticity that is too low are prone to collapse after pattern formation.

The organic component includes any component having a polymerizable group that is capable of polymerizing or copolymerizing and that has the specified T_{g} after polymerization. In one embodiment, the organic component that is copolymerized with the organosilicone component includes, but not limited, a vinyl group and a second group. When the organic component includes the vinyl group, the vinyl group enables vinyl polymerization of the organic component and, in some instances, copolymerization of the organic component with the organosilicone component.

The second group is selected from the group of alkyl groups, carboxyl groups, aromatic groups, cyclic hydrocarbon groups, hetero-cyclic groups, ether groups, and combinations thereof. The second group may also enable copolymerization of the organic component with the organosilicone component. Examples of organic components including the vinyl group and the second group that are suitable for the subject invention included those selected from the group of acrylates, styrenes, cyclic olefins, and combinations thereof. Specific examples of the organic components include styrene, methyl methacrylate (MMA), ethyl acrylate (EA), and combinations thereof.

The presence of the second group in the organic component controls the T_{g} of the polymerization product of the organic component and enables, in part, fine patterns to be formed in the resist film 12 formed from the copolymer that includes the organic component. The ability to form the fine patterns in the resist film 12 formed from the copolymer, in combination with the other properties of the copolymer attributed to the organosilicone component, makes resist films 12 formed from the copolymer ideal for use in the method of nanopatterning of the subject invention.

In another embodiment, the polymerizable group includes, but is not limited to, a carbonate, an amide, an imide, an ester, a urethane, a sulfone, an ether, and combinations thereof. When the organic component includes one or more of the polymerizable groups mentioned immediately above, the polymerizable group enables polymerization of the organic component and, in some instances, copolymerization of the organic component and the organosilicone component.

As set forth above, the copolymers formed from the organosilicone component and the organic component may be block copolymers, graft copolymers, etc. For purposes of the subject invention, the preferred copolymers include at least one of polystyrene-poly(dimethyl siloxane) block copolymer, poly(dimethyl siloxane)-methyl mathacrylate (MMA) graft copolymer, poly(dimethyl siloxane)-methyl acrylate graft copolymer, poly(dimethyl siloxane)-ethyl acrylate graft copolymer, methyl acrylate-isobornyl acrylate-poly(dimethyl siloxane) graft copolymer, polystyrene-poly(dimethyl siloxane) graft copolymer, poly(cyclic olefin)-poly(dimethyl siloxane) graft copolymer, polysiloxane-poly(ester) copolymer, polysiloxane-polyamide copolymer, polysiloxane-polyimide copolymer, polysiloxane-polyurethane copolymer, polysiloxane-polysulfone copolymer, polysiloxane-polyether copolymer, and polysiloxane-polycarbonate copolymer.

Preferably, a molar ratio of the organosilicone component to organic component used to form the copolymer is from 1:10 to 5:1, more preferably from 1:5 to 1:1. The relative amounts of the organosilicone component and the organic component may be adjusted depending on the particular application and process considerations. The copolymer formed from polymerization of the organosilicone component and the organic component in the above molar ratios exhibits the desired physical properties as described above.

An additive may be incorporated with the copolymer to modify, as necessary, desired physical and chemical properties of the copolymer. Additives typically do not integrate into the copolymer and are typically used in relatively small amounts. If included, such additives include, but are not limited to, those selected from the group of adhesion promoters, mold release agents, and combinations thereof. The adhesion promoters, such as 3-glycidoxypropyltrimethoxysilane, are utilized to improve surface adhesion of the substrate 14. The release agents are used to reduce the surface energy of the contact surfaces involved in the various techniques.

The copolymer is typically formed prior to providing the resist film 12. As such, the viscosity of the copolymer is relatively high, which may make application of the copolymer to the substrate 14 difficult. In order to more easily form the resist film 12, the copolymer is typically dissolved in a suitable solvent, such as an organic solvent, to form a solution of the copolymer. The solvent is typically a high boiling point (>80° C.) organic solvent and is preferably selected from the group of PGMEA, PGME, 2-heptanone, xylene, and combinations thereof. The viscosity of the solution of the copolymer is low in that it can be adequately applied onto the substrate 14. Preferably, solution of the copolymer has a kinematic viscosity that ranges from 1 to 10,000, more preferably from 10 to 1,000, and most preferably from 50 to 200, centistokes (cSt) at room temperature (approximately 20° C.). A lower viscosity of the solution of the copolymer helps achieve a thinner film of the copolymer, i.e., of the resist film 12. Varying the amount of the solvent relative to the amount of the copolymer assists in controlling the thickness of the resist film 12. This thickness may range from sub-100 nm to several microns.

The copolymer may be applied onto the substrate 14 through any method known in the art to form the resist film 12. The copolymer, more specifically the solution of the copolymer, is preferably applied onto the substrate 14 by spin-coating to form the resist film 12 in a thin and uniform manner. However, it is to be appreciated that the copolymer may also be applied by dip-coating, spray-coating, applying liquid droplets onto the substrate 14 prior to any contact printing, or other appropriate coating methods known in the art.

In one embodiment, the copolymer is applied directly to the substrate 14. As shown in FIG. 1, the pattern may then be formed in the resist film 12. In another embodiment, as shown in FIG. 4, a planarizing film 16 or an undercoating film is formed on the substrate 14, and the resist film 12 is formed on the planarizing film 16. In this embodiment, the planarizing film 16 is disposed between the substrate 14 and the resist film 12.

The planarizing film 16 is formed from a polymer. The polymer may have an oxygen plasma etch rate greater than an oxygen plasma etch rate of the copolymer for reasons to be described below. More specifically, the polymer may have an oxygen plasma etch rate that is at least 10 times greater than the oxygen plasma etch rate of the copolymer, and may be in excess of 100 times greater than the oxygen plasma etch rate of the copolymer. In other instances, it may be desirable for the planarizing film 16 to have a high oxygen plasma etch resistance when it is used as a masking material during pattern transfer into the underlying substrate 14.

Preferably, the polymer is an amorphous polymer with a T_{g} greater than 30° C. One example of a suitable polymer for the planarizing film 16 is poly(methyl methacrylate) (PMMA). However, other polymers including, but not limited to, polystyrene and polysilsesquioxanes, may also be suitable. One use for the planarizing film 16 formed from the polymer is for achieving better wetting of the substrate 14 by the copolymer, i.e., the resist film 12, during spin-coating of the copolymer onto the substrate 14. The better wetting of the substrate 14 ensures uniformity of the resist film 12.

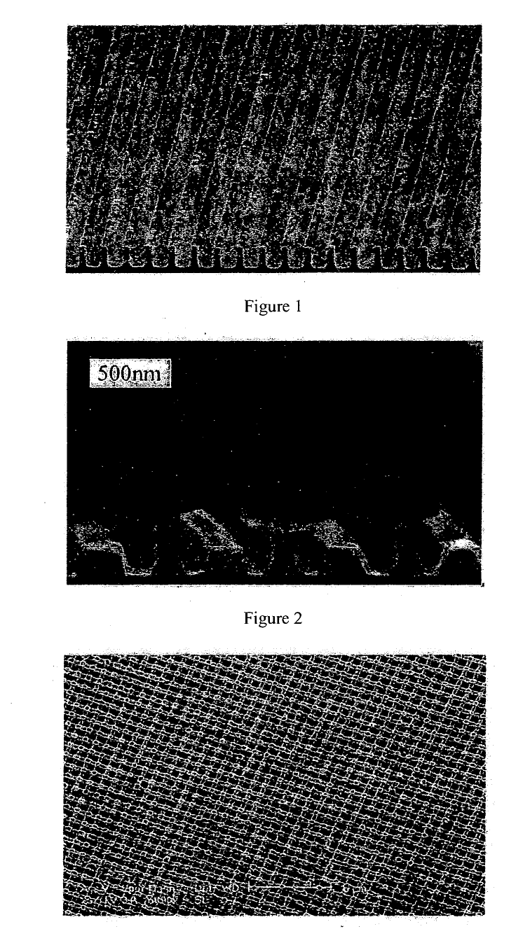

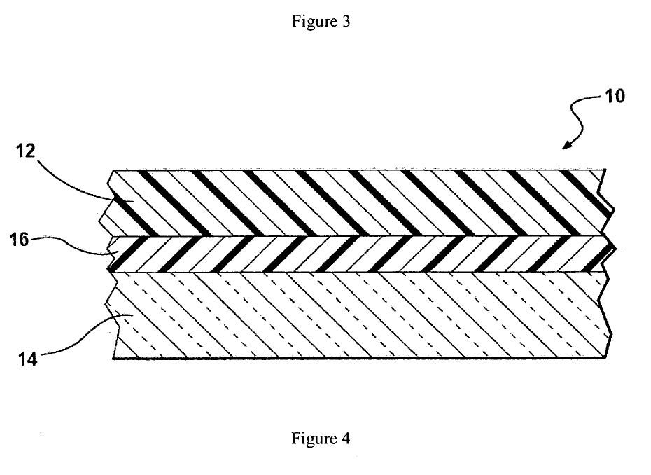

Referring to FIG. 2, the planarizing film 16 may also be used as a sacrificial layer in a lift-off process or to obtain large aspect-ratio structures. In the lift-off process, the planarizing film 16 is formed on the substrate 14, and the resist film 12 is formed on the planarizing film 16. The pattern, which is typically a short aspect-ratio structure, is then formed in the resist film 12. Residual copolymer remains in the pattern formed in the resist film 12. The copolymer is typically sensitive to certain plasma etching, such as fluorine plasma etching, and differences between fluorine plasma etch rates of the polymer in the planarizing film 16 and the copolymer in the resist film 12 may not be as pronounced as the differences between the respective oxygen plasma etch rates. As such, the residual copolymer may be fluorine plasma etched from the pattern in the resist film 12 to expose the planarizing film 16. Oxygen plasma etching is then used to form a pattern in the planarizing film 16. Although the copolymer in the resist film 12 is also subjected to the oxygen plasma etching, due to extreme differences in the oxygen plasma etch rates of the polymer in the planarizing film 16 and the copolymer in the resist film 12, etching of the resist film 12 is negligible as compared to etching of the planarizing film 16. As such, the resist film 12 functions as a mask to the planarizing film 16, and the planarizing film 16 is further etched beneath the resist film 12 to form an undercut feature. Optionally, as shown in FIG. 3, a metal layer, more specifically metal lines, may be disposed on the resist film 12. The planarizing film 16 may be etched as described above, then the metal layer may be disposed on the resist film 12 as desired. Exposed resist film 12 may then be at least partially dissolved with an appropriate solvent to achieve liftoff of the metal layer.

The following examples illustrating the method of nanopatterning, the resist film 12 having the pattern formed therein, and the article 10 including the resist film 12, as presented herein, are intended to illustrate and not limit the invention.

### EXAMPLE 1

A planarizing film 16 including PMMA is first formed on a silicon substrate 14. More specifically, the PMMA is dissolved in toluene to form a planarizing solution, which is spin-coated onto the silicon substrate 14 to form the planarizing film 16. The planarizing film 16 has a thickness of about 400 nm. A Polystyrene-poly(dimethyl siloxane) diblock copolymer containing approximately 50% of PS and 50% of PDMS by weight (GPC: Mₙ=45,000 g/mol; M_{w}/Mₙ=1.10) is dissolved in PGMEA. The copolymer, i.e., the solution of the copolymer, is spin-coated onto the planarizing film 16 to form a resist film 12 having a thickness of about 300 nm. A nano- and micron-scale pattern is formed in the resist layer using a NX-1000 imprinter commercially available from Nanonex, Inc. of Monmouth Junction, N.J. A scanning electron microscopy (SEM) micrograph of the pattern is illustrated in FIG. 1.

### EXAMPLE 2

The planarizing film 16 and the resist film 12 are formed on the substrate 14 as described above in Example 1. However, the patterns are formed through imprinting so as not to completely extend through the resist film 12 into the planarizing film 16. After imprinting, the mold and the substrate 14 are separated and a replica of the mold pattern is imprinted into the resist film 12 (see, for example, FIG. 1).

Residual copolymer in the pattern is removed through fluorine plasma etching to expose the planarizing film 16. A lift-off process is then carried out by oxygen plasma etching the resist film 12 and the planarizing film 16. The oxygen plasma etch rate of the copolymer is about 0.98 nm/min., and the oxygen plasma etch rate of the PMMA is about 110 nm/min. As a result of this disparity in oxygen plasma etch rates, the undercut feature is achieved, as illustrated in FIG. 2. Due to the presence of silicon in the resist film 12, the resist film 12 shows very interesting oxygen plasma etching properties. For example, a 20 nm layer is removed from the resist film 12 during the first three minutes of oxygen plasma etching; but the etching rate of the resist film 12 is much slower afterwards. This is likely due to the formation of silicon oxide on the top layer of the resist film 12 after the oxygen plasma etching, which acts as a hard mask to shield the inner part of the resist film 12 from being attacked by oxygen plasma. This property is very useful because it imparts the resist film 12 with much higher etching selectivity than common organic based nanoimprint resists, such as PMMA and PS. It also removes the constraint of the thickness of the planarizing film 16. Metal lines are then deposited onto the resist film 12, as also illustrated in FIG. 2, and the remaining resist film 12 that is exposed is then partially dissolved using acetone to complete the lift-off process. FIG. 3 illustrates a metal grid formed according to the same method as described above.

The invention has been described in an illustrative manner, and it is to be appreciated that the terminology which has been used is intended to be in the nature of words of description rather than of limitation. Obviously, many modifications and variations of the present invention are possible in view of the above teachings. It is, therefore, to be appreciated that within the scope of the claims the invention may be practiced otherwise than as specifically described.

What is claimed is:

1. A method of nanopatterning comprising the steps of;
providing a resist film (12) comprising a copolymer of an organosilicone component and an organic component, and
forming a pattern in the resist film (12).

2. A method as set forth in claim 1 wherein the organosilicone component comprises a silicone group selected from the group of an (SiR₂O) group, an (SiRO_{2/3}) group, and combinations thereof, wherein R is selected from the group of an amino group, a hydroxyl group, an ether group, a carboxyl group, hydrogen, a phenyl group, a hydrocarbon group, a fluorocarbon group, and combinations thereof.

3. A method as set forth in claim 2 wherein the organosilicone component comprises a dialkyl silane.

4. A method as set forth in claim 1 wherein the organic component is selected from the group of acrylates, styrenes, cyclic olefins, and combinations thereof.

5. A method as set forth in claim 1 wherein the copolymer is further defined as at least one of polystyrene-poly(dimethyl siloxane) block copolymer, poly(dimethyl siloxane)-methyl mathacrylate (MMA) graft copolymer, poly(dimethyl siloxane)-methyl acrylate graft copolymer, poly(dimethyl siloxane)-ethyl acrylate graft copolymer, methyl acrylate-isobornyl acrylate-poly(dimethyl siloxane) graft copolymer, polystyrene-poly(dimethyl siloxane) graft copolymer, poly(cyclic olefin)-poly(dimethyl siloxane) graft copolymer, polysiloxane-poly(ester) copolymer, polysiloxane-polyamide copolymer, polysiloxane-polyimide copolymer, polysiloxane-polyurethane copolymer, polysiloxane-polysulfone copolymer, polysiloxane-polyether copolymer, and polysiloxane-polycarbonate copolymer.

6. A method as set forth in claim 1 wherein a molar ratio of the organosilicone component to the organic component in the copolymer is from 1:10 to 5:1.

7. A method as set forth in claim 1 wherein the step of forming the pattern in the resist film (12) comprises at least one of nanoimprint lithography (NIL), thermal embossing, nanoscale contact printing, UV-assisted nanoimprint lithography, Step-and-Flash Nanoimprint Lithography (S-FIL), and combined-nanoimprint-and-photolithography.

8. A method as set forth in claim 1 further comprising the step of applying the copolymer to a substrate (14) to form the resist film (12).

9. A method as set forth in claim 8 wherein the copolymer is applied through at least one of spin-coating, dip-coating, spray-coating, and applying the copolymer onto the substrate (14) as liquid droplets.

10. A method as set forth in claim 1 further comprising the step of forming a planarizing film (16) on a substrate (14).

11. A method as set forth in claim 10 wherein the step of providing the resist film (12) comprises applying the copolymer onto the planarizing film (16) to form the resist film (12).

12. A method as set forth in claim 11 further comprising the step of plasma etching residual copolymer from the pattern in the resist film (12) to expose the planarizing film (16).

13. A method as set forth in claim 11 further comprising the step of oxygen plasma etching the planarizing film (16) to form a pattern in the planarizing film (16).

14. A method as set forth in claim 13 further comprising the step of disposing a metal layer on the resist film (12).

15. A resist film (12) having a pattern formed therein, said resist film (12) comprising;
a copolymer of an organosilicone component and an organic component.

16. A resist film (12) as set forth in claim 15 wherein said organosilicone component comprises a silicone group selected from the group of an (SiR₂O) group, an (SiRO_{2/3}) group, and combinations thereof, wherein R is selected from the group of an amino group, a hydroxyl group, an ether group, a carboxyl group, hydrogen, a phenyl group, a hydrocarbon group, a fluorocarbon group, and combinations thereof.

17. A resist film (12) as set forth in claim 16 wherein said organosilicone component comprises a dialkyl silane.

18. A resist film (12) as set forth in claim 15 wherein said organic component is selected from the group of acrylates, styrenes, cyclic olefins, and combinations thereof.

19. A resist film (12) as set forth in claim 32 wherein said copolymer is further defined as at least one of polystyrene-poly(dimethyl siloxane) block copolymer, poly(dimethyl siloxane)-methyl mathacrylate (MMA) graft copolymer, poly(dimethyl siloxane)-methyl acrylate graft copolymer, poly(dimethyl siloxane)-ethyl acrylate graft copolymer, methyl acrylate-isobornyl acrylate-poly(dimethyl siloxane) graft copolymer, polystyrene-poly(dimethyl siloxane) graft copolymer, poly(cyclic olefin)-poly(dimethyl siloxane) graft copolymer, polysiloxane-poly(ester) copolymer, polysiloxane-polyamide copolymer, polysiloxane-polyimide copolymer, polysiloxane-polyurethane copolymer, polysiloxane-polysulfone copolymer, polysiloxane-polyether copolymer, and polysiloxane-polycarbonate copolymer.

20. A resist film (12) as set forth in claim 15 wherein a molar ratio of said organosilicone component to said organic component in said copolymer is from 1:10 to 5:1.

21. An article (10) comprising;
a substrate (14),
a resist film (12) formed on said substrate (14) and having a pattern formed therein;
said resist film (12) comprising a copolymer of an organosilicone component and an organic component.

22. An article (10) as set forth in claim 21 wherein said organosilicone component comprises a silicone group selected from the group of an (SiR₂O) group, an (SiRO_{2/3}) group, and combinations thereof, wherein R is selected from the group of an amino group, a hydroxyl group, an ether group, a carboxyl group, hydrogen, a phenyl group, a hydrocarbon group, a fluorocarbon group, and combinations thereof.

23. An article (10) as set forth in claim 22 wherein said organosilicone component comprises a dialkyl silane.

24. An article (10) as set forth in claim 21 wherein said organic component is selected from the group of acrylates, styrenes, cyclic olefins, and combinations thereof.

25. An article (10) as set forth in claim 21 wherein the copolymer is further defined as at least one of polystyrene-poly(dimethyl siloxane) block copolymer, poly(dimethyl siloxane)-methyl mathacrylate (MMA) graft copolymer, poly(dimethyl siloxane)-methyl acrylate graft copolymer, poly(dimethyl siloxane)-ethyl acrylate graft copolymer, methyl acrylate-isobornyl acrylate-poly(dimethyl siloxane) graft copolymer, polystyrene-poly(dimethyl siloxane) graft copolymer, poly(cyclic olefin)-poly(dimethyl siloxane) graft copolymer, polysiloxane-poly(ester) copolymer, polysiloxane-polyamide copolymer, polysiloxane-polyimide copolymer, polysiloxane-polyurethane copolymer, polysiloxane-polysulfone copolymer, polysiloxane-polyether copolymer, and polysiloxane-polycarbonate copolymer.

26. An article (10) as set forth in claim 21 wherein a molar ratio of said organosilicone component to said organic component in said copolymer is from 1:10 to 5:1.

27. An article (10) as set forth in claim 21 further comprising a planarizing film (16) disposed between said substrate (14) and said resist film (12).

28. An article (10) as set forth in claim 27 wherein said planarizing film (16) is formed from a polymer having an oxygen plasma etch rate greater than an oxygen plasma etch rate of said copolymer.

29. An article (10) as set forth in claim 27, wherein said planarizing film (16) is etched to form a pattern in said planarizing film (16).

30. An article (10) as set forth in claim 29 wherein a metal layer is disposed on said resist film (12).
